(19) United States
(12) Patent Application Publication
(10) Pub. No.: US 2012/0110011 A1
(43) Pub. Date: May 3, 2012

(54) MANAGING APPLICATION ACCESS ON A COMPUTING DEVICE

(75) Inventors: Carl F. Allen, Highland, UT (US); Nathan B. Moon, Kaysville, UT (US); Jason A. King, Roy, UT (US)

(73) Assignee: IHC Intellectual Asset Management, LLC, Salt Lake City, UT (US)

(21) Appl. No.: 13/283,846

(22) Filed: Oct. 28, 2011

Related U.S. Application Data
(60) Provisional application No. 61/408,243, filed on Oct. 29, 2010.

(51) Int. Cl. G06F 17/30

(52) U.S. Cl. 707/770; 707/E17.014

(57) ABSTRACT

A computing device that is configured for managing application access is described. The computing device includes a processor and instructions stored in memory. The computing device determines one or more connectors needed to execute one or more commands using a mapping. The computing device executes the one or more commands using the one or more connectors. User information is updated to reflect any changes. One or more audit records are generated and stored.

### RELATED APPLICATIONS

This application claims the benefit of U.S. Provisional Patent Application No. 61/408,243 filed on Oct. 29, 2010. This provisional patent application is expressly incorporated herein by reference.

### TECHNICAL FIELD

The present invention relates generally to computers and computer-related technology. More specifically, the present invention relates to managing application access.

### BACKGROUND

The use of computers and computer-related technology has been rapidly expanding. Computers now play an important role in the daily lives of numerous people. For example, many people use computers for work, communication and entertainment. At work, a person might use a computer to type documents, do research or retrieve information, run complex simulations, give a presentation and communicate with coworkers. Additionally, networking and network-related technologies have accelerated computer use. Many companies now use large computer networks to improve communication and productivity. For example, many companies provide computer networks to their employees such that their employees can store and share data, communicate with each other and access a variety of network applications.

The advancement of computers and network technology has not come without challenges. As computer networks become more prevalent, managing security and access for data and applications has become an increasingly difficult and complex task. Managing these issues may be particularly daunting for companies having a large number of employees with differing authority to access a variety of applications and sensitive data. For example, many companies in the medical services industry keep extensive stores of sensitive data. Moreover, these companies may need to grant access to particular computer applications to some employees but not to others. Employees may also need access to different applications to complete the tasks assigned to them. As illustrated by the above discussion, systems and methods that improve the ability to administer access to one or more applications may be beneficial.

### BRIEF DESCRIPTION OF THE DRAWINGS

FIG. 1 is a block diagram illustrating several modules wherein systems and methods for managing application access may be implemented;

FIG. 2 is a block diagram illustrating a more specific configuration of several modules that may be used to manage application access;

FIG. 3 is a block diagram illustrating several possible configurations of systems and methods for managing application access;

FIG. 4 is a block diagram illustrating one example configuration of systems and methods for managing application access;

FIG. 5 is a flow diagram illustrating one configuration of a method for managing application access;

FIG. 6 is a thread diagram illustrating examples of the operation of systems and methods for managing application access;

FIG. 7 is a flow diagram illustrating a more specific configuration of a method for adding user access to an application;

FIG. 8 is a block diagram illustrating one example of an access management application according to systems and methods for managing application access; and

FIG. 9 illustrates various components that may be utilized in a computing device.

### DETAILED DESCRIPTION

As discussed above, managing access to applications may be a difficult and complex task. This can be particularly true for companies that have a large number of employees with differing authorizations to access differing applications that use differing procedures to grant access. The systems and methods disclosed herein provide a way to manage user access to multiple applications that use different procedures in granting access.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods. It should be noted that the Figures may use various abbreviations for convenience, where “information” is abbreviated as “Info,” “management” as “Mgmt,” “human resources” as “HR,” “application” as “App,” “database” as “DB” and “administrator” as “Admin,” for example.

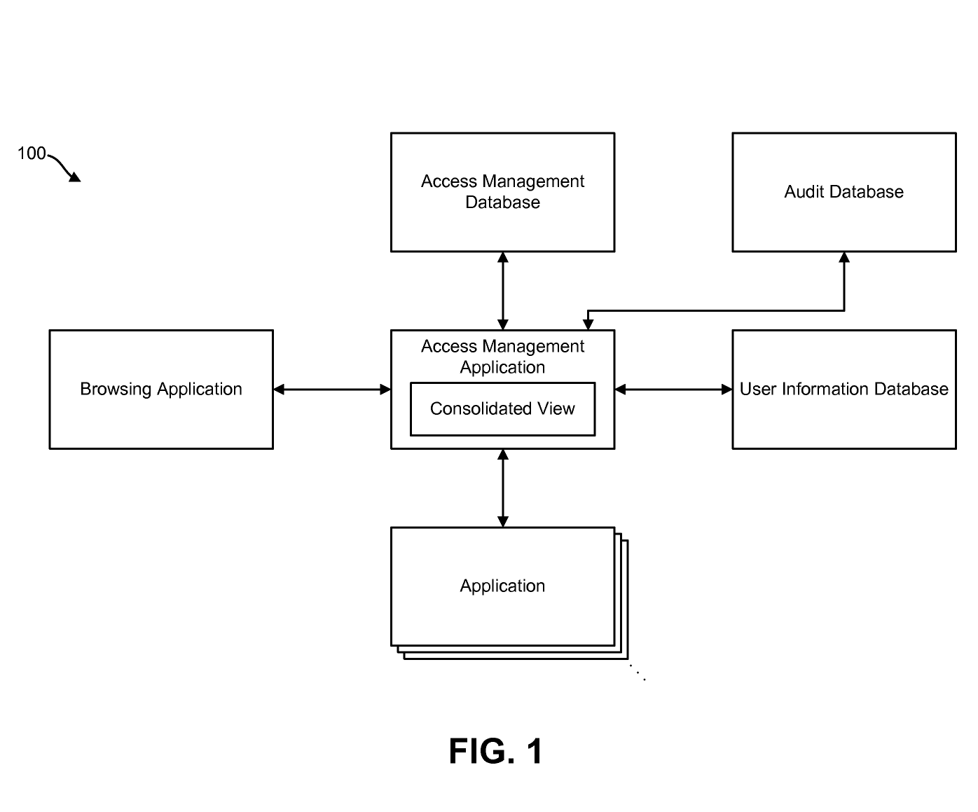

FIG. 1 is a block diagram illustrating several modules 100 wherein systems and methods for managing application access may be implemented. The modules illustrated may be implemented in hardware, software or a combination of both. In particular, FIG. 1 illustrates several functional modules that may be used to manage application access. An access management application may be connected to and/or communicate with a browsing application, an access management database, an audit database, a user information database and/or one or more applications. Each of the one or more applications may use different procedures and/or structures in order to grant user access to the applications. For example, one application may require a username and password for access, while another might use a number to identify a user or group of users. Furthermore, some applications may also set forth differing roles that provide different levels of access to a user, depending on that user's role. In general, the access management application allows access to multiple applications. For example, the access management application “ties” multiple applications together. For instance, the access management application may allow access to each of the multiple applications and/or interaction between applications.

The user information database may contain several pieces of user information. For example, the user information database may contain a user name, user identification number, employee number, and other data for multiple users. For example, the user information database may contain user information for all of the employees in a company. This user information database may be populated, for example, using human resource (HR) records from a company. Alternatively, a user may enter information into the user information database. For example, a user may register or a manager may enter the information in an employee's behalf, etc. The audit database may store audit records on actions taken by the access management application. The access management database may generally contain different kinds of data that the access management application may use to communicate with the one or more applications, the user information database and/or the audit database. For example, the access management database may store and provide information that the access management application may use to compatibly communicate according to the different procedures, structures and/or information (e.g., to grant access to a user) used by the one or more applications. In other words, the systems and methods disclosed herein may provide one set of user information that may be used to access multiple applications.

Search functionality may also be provided by the access management application and/or the databases described herein. For example, the access management application may provide a capability to search the access management database, the audit database and/or the user information database. Different types of searches may be conducted, using different search terms, database keys and filtering (e.g., within date ranges, within record ranges (e.g., alphabetical or numerical ranges, etc.), using selected fields for search, etc.), for example. In some configurations, the applications may also be searched (e.g., the access management application may use application functionality to search application data).

The browsing application may provide access to the access management application. In one configuration, for example, the browsing application is located remotely from the access management application. This configuration may allow users on remote and/or different platforms to use the access management application. In another configuration, the browsing application is not located remotely from the access management application. In yet another configuration, the browsing application is optional and the access management application may be accessed directly by a user.

As illustrated in FIG. 1, the access management application may include a consolidated view. This consolidated view may provide a single view of a user's access to various differing applications. More specifically, it may be used to display all of the applications that a particular user has access to, and what kinds of access are provided to that user.

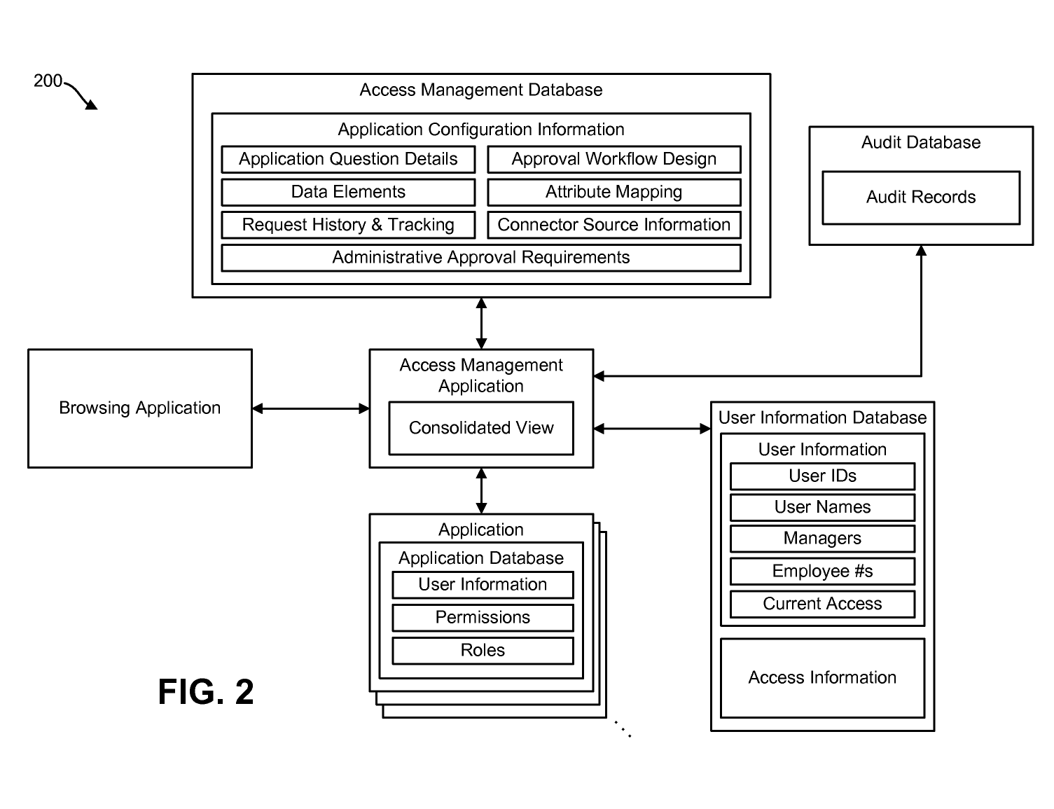

FIG. 2 is a block diagram illustrating a more specific configuration of several modules 200 that may be used to manage application access. The access management application may be connected to and/or communicate with an access management database, an audit database, a user information database, one or more applications, one or more application databases, and/or a browsing application. The user information database may include user information and/or access information. One example of a user information database is a directory that operates in accordance with the Lightweight Directory Access Protocol (LDAP). The user information may include, for example, a user identification (ID), a user name, a manager, an employee number and a list of current access for multiple users. The list of current access may include a list of applications that a user currently has access to. The access information may include information such as user names, passwords, permissions and/or roles for a particular user. In some configurations, this access information may be used by one or more applications to grant access and/or a particular type or level of access to a user. This access information may be similar in function to information contained in an application database (e.g., included in an application) in some cases.

The one or more applications may each optionally include an application database. Each application database may differ as to the information that it stores and how that information is used. An application database may, for example, include user information, permissions and/or roles. For example, one application may require user information such as a user name and password to allow access to the application. Additionally or alternatively, the application database may include information about certain permissions given to users. For example, one user may have permission to only view information provided by an application while another may have permission to modify that information. Furthermore, an application may grant differing access to data and/or functionality between users. In some configurations, these permissions may be attached to roles. For example, one user may have an administrative role in a time keeping application (e.g., to approve time charges on a project) while another user may have non-administrative access (e.g., to submit charges on a project). Other examples include card access applications where users with different roles have different authorization to gain entry in certain areas of a building (e.g., security guard, janitorial, manager access, etc.) or where certain employees may have access to patient information in a medical context (e.g., doctor, nurse, receptionist, researcher, etc.). In yet another example, one application may simply need to have a user name on a list to grant full access.

Each user application database may also be structured differently in a communications context and/or structure context. For example, one application database may be a Microsoft SQL database, another may be a Sybase database, another may be an Oracle database and yet another may be an LDAP V-3 compliant directory. Other types of databases may be used. Each of these application databases may use different protocols and data formats for communication and operation. That is, each application database may accept queries and/or commands in different formats. For instance, some applications may rely on the Lightweight Directory Access Protocol (LDAP), while others may be reliant on Open Database Connectivity (ODBC) databases. As can be seen, many applications may use many differing structures and differing types of information to manage application access.

The access management database may include information that allows the access management application to communicate with the one or more applications and/or their databases, for example. In the configuration illustrated in FIG. 2, the access management database includes application configuration information (which may include one or more application configurations). For example, the application configuration information may include application question details, data elements (including mandatory or optional designation), request history and tracking, administrative approval requirements, approval workflow design, attribute mapping and/or data connector information, etc. In other words, the access management application may use one or more pieces of information included in the application configuration information to communicate with each application and/or application database.

The connector source information, data connector information or “connector” may be (or point to) processes that allow the access management application to communicate with differing applications. For example, the connector source information may allow the access management application to send commands to one or more application databases to view, create (e.g., add), modify or delete database entries. In one configuration, the connector source information includes database query statements that can be used by the access management application to query information from a particular kind of application database. In other words, a connector may translate access management application commands into statements that are compatible with the application or application database at hand.

An attribute mapping or “mapping” may include information that maps a particular application to a particular connector. That is, a mapping may dictate which connector needs to be used by the access management application to communicate with a particular application or application database.

The administrative approval requirements may indicate requirements for administrators to approve access to one or more applications. The approval workflow design may indicate the workflow steps that need to be followed for approval to access one or more applications. The administrative approval requirements and approval workflow design may define the approval requirements and processes that must be satisfied before the application can proceed to the next step. For example, before an administrator can approve a request for access, an appropriate role for the user may need to be selected. The application question details may provide details on the kinds of questions used for granting access to one or more applications. Other data elements may also be included. For example, data elements may indicate whether particular access requirements are mandatory or optional, the specific facilities or entities the user may be able to access and/or whether the request must be approved by another administrator.

As mentioned above, the access management database may include request history and tracking. The request history and tracking information may include, for example, requests. Requests may be database records of requests for access or access modification. For example, a user may desire to have access to a particular application. That user may use the browsing application to use the access management application to submit a request for access to a particular application. The access management application may obtain information from the user information database to identify the user and attach that information to a request for access that may be stored on the access management database. These requests may be reviewed by an administrator, for example, who may grant or deny the request for access. For example, an administrator may use the browsing application to use the access management application, which may provide a list of requests in the consolidated view.

The consolidated view may allow a user to view application access for one or more users. For example, the access management application may retrieve data (e.g., by using one or more mappings and/or connectors) from the user information database and/or one or more application databases to display a user's access to one or more applications in the consolidated view. The consolidated view may thus be useful to efficiently display a user's access to many disparate applications.

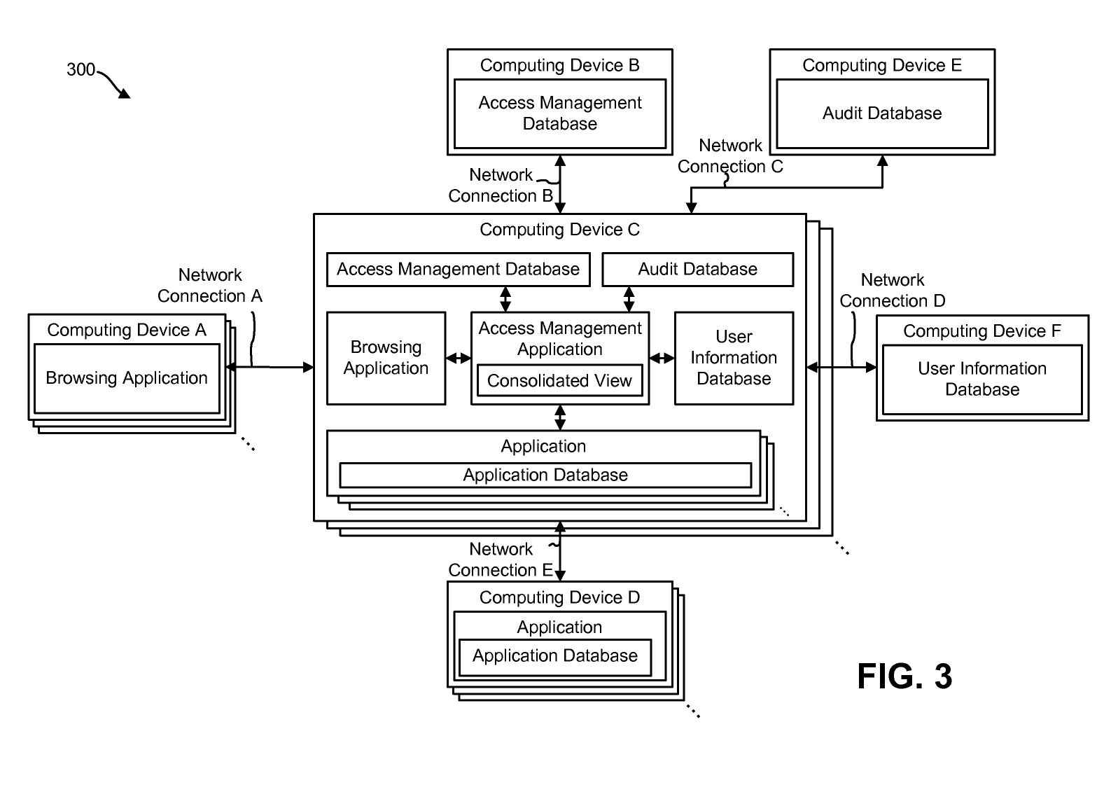

FIG. 3 is a block diagram illustrating several possible configurations 300 of systems and methods for managing application access. Several computing devices are shown. Each of the computing devices shown in FIG. 3 may be, for example, a web server, a desktop computer, a laptop computer, a tablet device, a wireless handheld computing device (e.g., smart phone), etc. In general, the various modules illustrated in FIG. 1 (e.g., and/or FIG. 2) may all be included in a single computing device C. Alternatively, one or more of the modules may be included in remotely networked computing devices. For example, in one configuration, the access management database, the access management application (including the consolidated view), the audit database, the user information database, one or more applications (each including one or more application databases, for example) and the browsing application may all be included on computing device C.

Alternatively, one or more of the aforementioned modules may be located on one or more computing devices that are networked to computing device C. For example, in one configuration, the browsing application may be located on computing device A that has network connection A with computing device C. Furthermore, there may be multiple computing devices A, each having one or more browsing applications and each having a network connection with computing device C. For example, a first computing device A may be an employee's desktop computer while a second computing device A may be an administrator's desktop computer.

As illustrated in FIG. 3, the access management database may be located on computing device B, which may have network connection B with computing device C. Moreover, computing device E may include the audit database and may use network connection C to communicate with computing device C. Additionally or alternatively, the user information database may be located on computing device F that communicates with computing device C via network connection D. Finally, one or more applications (e.g., each including one or more application databases) may be located on one or more computing devices D, each using one or more network connections E to communicate with computing device C. It should also be noted that multiple computing devices C may be used (e.g., for redundant or parallel operation in order to provide greater reliability or performance).

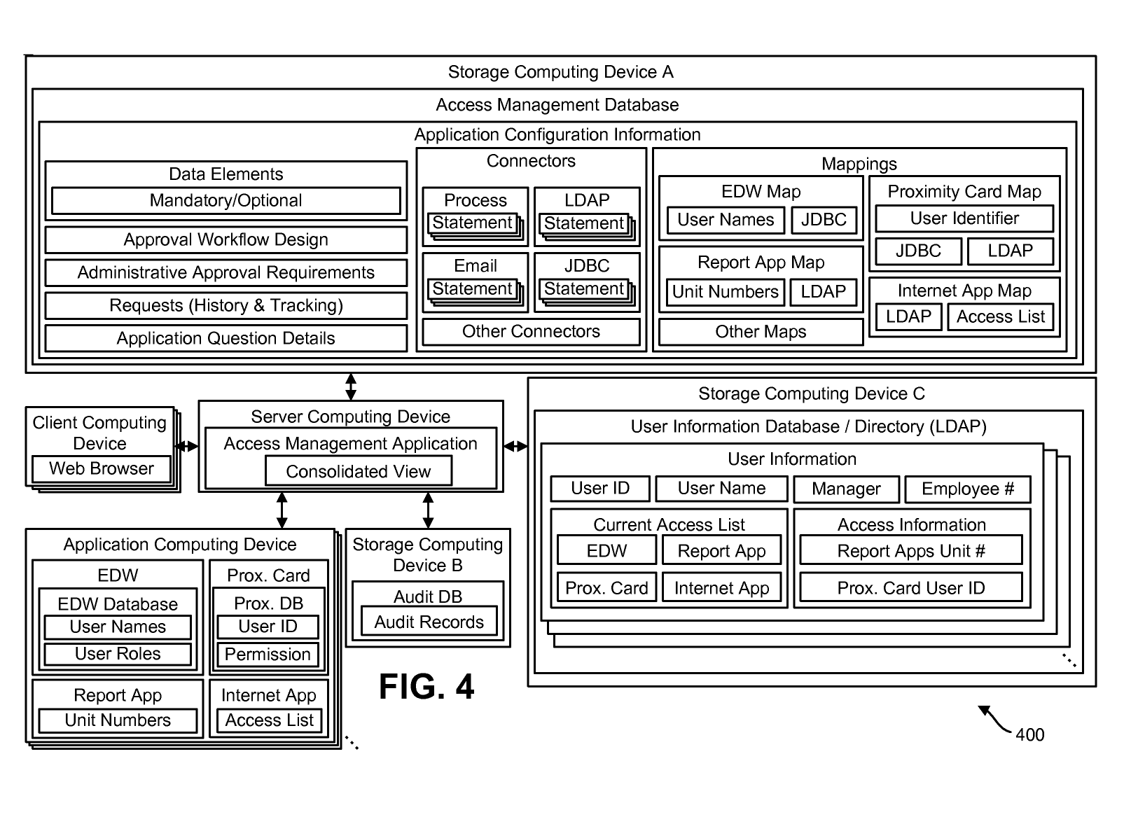

FIG. 4 is a block diagram illustrating one example configuration 400 of systems and methods for managing application access. In this example, a server computing device is connected (e.g., using one or more networks) to storage computing device A, storage computing device B, storage computing device C, one or more application computing devices and one or more client computing devices. The server computing device includes an access management application that may provide a consolidated view.

The server computing device may communicate with storage computing device C that includes a user information database and/or access information. The user information database or directory may be, for example, a directory that operates in accordance with LDAP. The user information database may contain database tables that include information about one or more users. In this example, user information for one user includes a user ID, user name, the user's manager, the user's employee number and a current access list. As illustrated, a user may have, for example, access to four applications listed in the current access list. The current access list includes a listing for an Enterprise Data Warehouse (EDW) application, a report application, a proximity card application and an internet application. Thus, the current access list reflects which applications (e.g., on the one or more application computing devices) a particular user has access to. As mentioned, the user information database may also include access information. The access information in the user information database will be discussed in greater detail below.

The server computing device may also communicate with one or more application computing devices. As illustrated in FIG. 4, four example applications are shown on an application computing device. It should be noted, however, that an application computing device may include many more or different applications and the applications may be distributed amongst many application computing devices. Each of the applications illustrated may use different procedures and/or information for managing application access. For example, an EDW application may include an EDW database including user names and user roles. The EDW application may use these user names and user roles to manage access to the application and/or data provided by the application. For example, if a user has a user name included in the EDW database, that user may have access to the EDW application. However, that user may also have a user role that dictates the functionality and/or data that may be accessed by that user according to the EDW application. For example, one user may have a “doctor” user role while another user may have a “researcher” user role, each being able to access certain data and/or functionality.

As described above, the user information database/directory may be an LDAP directory. The one or more applications may use the user information database to store access information for one or more users. In this example, the report application utilizes unit numbers. A unit number may be a number that indicates a particular user. For example, unit number “12345” could give access to a user to whom that unit number has been assigned. In this example, however, a user's unit number may be stored in the user information database access information. Thus, a particular user may have a report application unit number “12345” stored in the access information in the user information database.

A proximity card application may include a proximity card database. In this example, the proximity card database includes user permissions (e.g., representing what areas of a building or parking lot that a user can gain entrance to). As illustrated, however, the proximity card application may use more data than just permissions data to handle access. For example, the proximity card application may require a user ID stored in the user information database to grant application access. Thus, an entry for a proximity card user ID is illustrated in the access information in the user information database.

Access to an internet application may be managed in a simpler fashion in this example. Here, a user may have access to the internet application simply if the internet application is included in the user's access list. Thus, several different examples have been shown that illustrate how some applications may use data only from their own database for access, some may use only information stored in a user access database and some may use a combination of both.

Storage computing device A may store application configuration information in the access management database that coordinates application access according to differing access schemes. More specifically, the access management database may include mappings that indicate the kind of information used by each application and/or application database for user access. Such information may include an access list, permissions, roles, etc. Moreover, the mappings may indicate one or more connectors that may be used to interact with the user information database and each application and/or application database. In this example, the mappings include an EDW application map, a proximity card application map, a report application map, an internet application map and other maps. The EDW map indicates that the EDW application uses user names (and could also indicate that the EDW application uses user roles) for access and also that a Java Database Connectivity (JDBC) connector should be used to communicate with the EDW database. Thus, when the access management application receives a request to add, modify or delete a user's access in the EDW database, the EDW map indicates that it should use the JDBC connector to do so. As illustrated, the JDBC connector is included in the connectors in the access management database. The JDBC connector may include several statements that the access management application may use to generate EDW database queries or commands For example, the access management application may use an add statement included in the JDBC connector to add a user name and/or role to the EDW database. Other statements may be used to modify, delete or view the information in the EDW database. For instance, the access management application may send a command to the JDBC connector which may translate that command into a SQL statement used to perform some operation on the EDW database.

The report application map indicates that the report application uses a unit number and that the access management application should use an LDAP connector to view, add, modify or delete a report application unit number in the access information included in the user information database. The LDAP connector may contain statements to perform these actions.

The proximity card application map may indicate to the access management application that a user ID and/or permissions are used by the proximity card application. In this case, the proximity card application map indicates that the access management application should use a JDBC connector to access the proximity card database (e.g., to view, add, modify or delete a permission) and an LDAP connector to access the user information database (e.g. to view, add, modify or delete a proximity card user ID).

The internet application map may indicate that access to the internet application depends on whether a user has the internet application listed in that user's current access list. Furthermore, the internet application map may indicate that the LDAP connector's statements should be used by the access management application to view, add, modify or delete the listing of the internet application in the current access list of the user information database. As illustrated, other maps and other connectors may be provided, depending on the implementation. For example, a map and a connector could be used by the access management application to synchronize with Microsoft Active Directory. Two other connectors may be the process connector and the email connector that may allow the access management application to send commands to processes as well as email applications. The process connectors provide the ability to generate data that can be consumed by downstream workflow processes. For example, when creating a new user, the process connector can be set up to auto-generate a password to the user. The email connector can support the notification of user or groups of subsequent approvals or denials. For example, the email connector may be used to send a notification to a support group to modify a user's access based on the appropriate workflow.

As discussed above, the application configuration information may include other pieces of information used to coordinate access to one or more applications. For example, the application configuration information may also include data elements (including a mandatory/optional designation), approval workflow design, administrative approval requirements, request history and tracking and/or application question details.

A user may use the web browser on a client computing device to access the access management application on the server computing device. As discussed above, the access management application may provide a consolidated view of a user's application access. When a user accesses the consolidated view, for example, the access management application may use the appropriate maps and connectors to retrieve application access data for a user from a variety of disparate sources. For example, the access management application may use the maps and connectors to retrieve data from each application database and the user information database for display. The access management application may also allow a user to add, modify or delete information in those databases. It should be noted that when a change in information is made (or when information is retrieved, for example) that the access management application may generate and write one or more audit records to the audit database on storage computing device B. This may provide tracking of the various changes that may occur (e.g., who approved access, when/what access was given to whom, etc.). This auditing feature may be particularly useful in the context of medical data access regulation and auditing, for example.

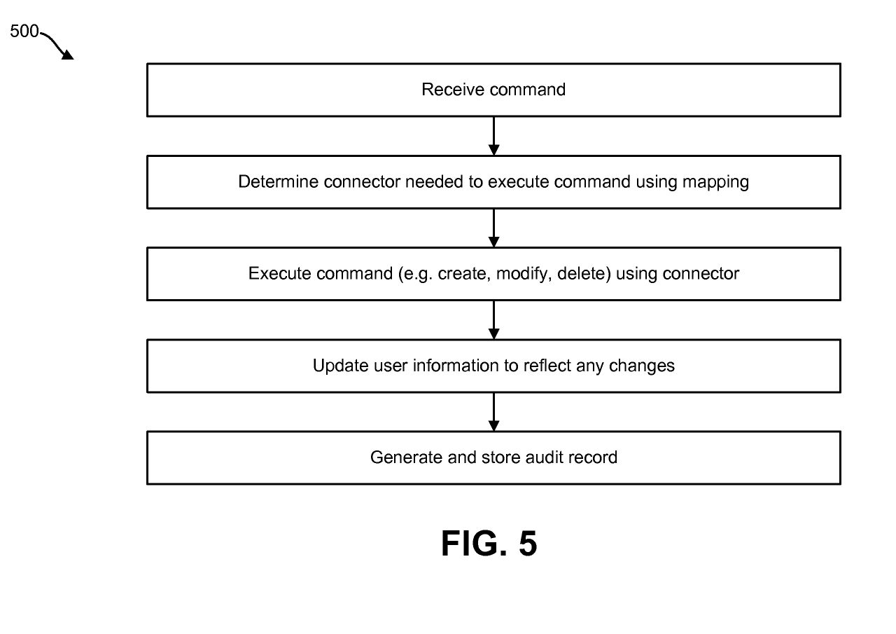

FIG. 5 is a flow diagram illustrating one configuration of a method 500 for managing application access. A computing device may receive a command The command may originate locally (e.g., from a computing device where the access management application is located) or remotely (e.g., from a networked computing device having a browsing application). Examples of commands include a command to retrieve information for viewing, a command to give or revoke access for a particular user or a command to modify a user's access. The computing device may determine a connector needed to execute the command using a mapping. For example, the access management application may retrieve a map from an access management database that indicates which connector should be used. The computing device may execute the command using the determined connector. For example, the access management application may use a connector to translate a retrieve (e.g., for viewing), add, modify or delete (e.g., remove) command into a statement that may be used by a particular application or application database. The computing device may update user information to reflect any changes. For example, if application access is granted to a user (e.g., by writing a user name to an application database), the access management application may add that application to a user's current access list in the user information database. The computing device may also generate and store an audit record that indicates any operations performed.

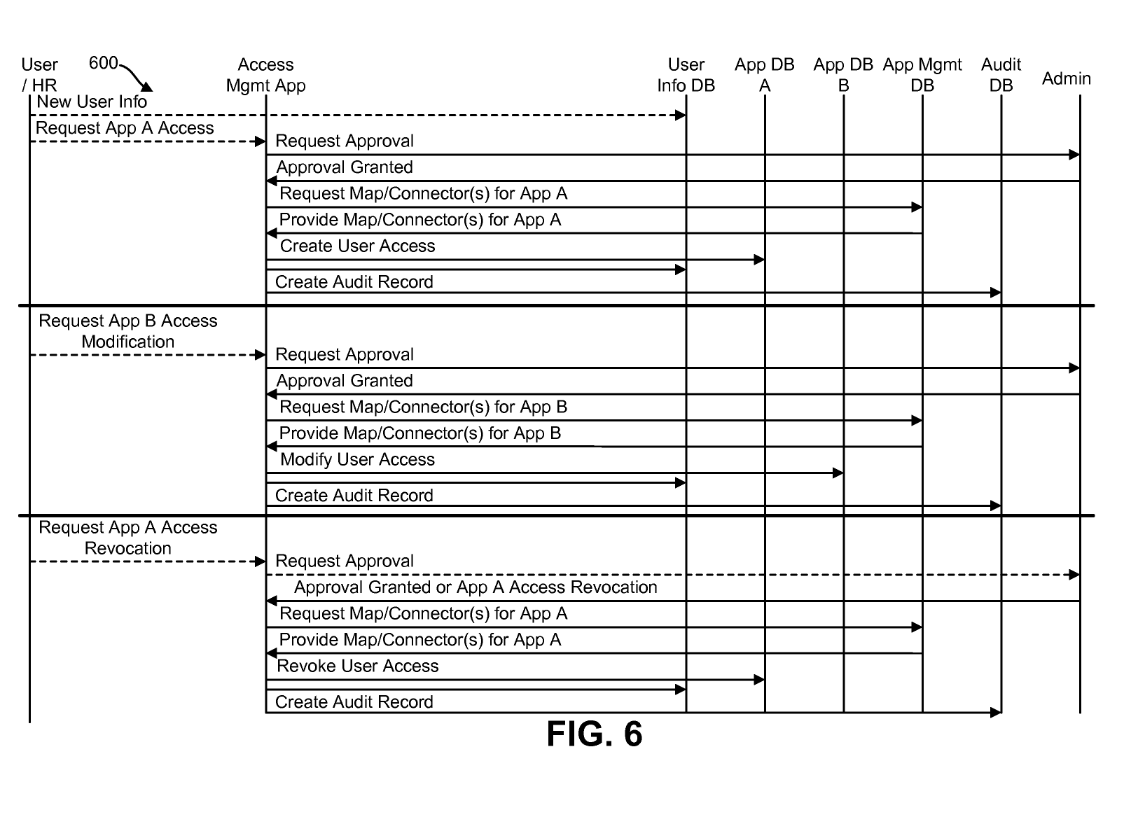

FIG. 6 is a thread diagram illustrating examples 600 of the operation of systems and methods for managing application access. It should be noted that several abbreviations are used in FIG. 6 for convenience. In FIG. 6, “information” is abbreviated as “Info,” “management” as “Mgmt,” “human resources” as “HR,” “application” as “App,” “database” as “DB” and “administrator” as “Admin.” Three examples are given.

The first example illustrates when a new employee may be given access to an application. In the first example, a user (e.g., or a human resources department of a company, etc.) may submit new user information. The new user information may be added to a user information database. Additionally or alternatively, a user may request access to application A. The access management application may receive this request and send a request for approval to an administrator. In other words, the request may be stored on the application management database for access by an administrator. The administrator may send an approval or denial of the request. In this example, the access management application receives a message granting approval for the user's access to application A. The access management application may request a map and/or connector(s) for application A from the application management database. The application management database may provide the appropriates map and/or connector(s) to the access management application. The access management application may use the map and/or connector(s) to create user access by performing one or more operations on one or both of the application database A and the user information database (e.g., adding a user name, adding the application to the current access list, etc.). The access management application may also create an audit record and store it in the audit database.

In the second example, a user's access to an application is modified. In this example, the user submits a request to modify his access to application B. The access management application sends an approval request to an administrator (e.g., again, possibly via the application management DB, possibly by email, etc.). In this example, the administrator submits an approval to the access management application. The access management application requests a map and/or connector(s) for application B to the application management database. The application management database returns the appropriate map and/or connector(s). Using the connectors, the access management application sends commands (e.g., translated into statements) to the application B database and/or the user information database. For example, the access management application may send commands to modify the role of a particular user in an application B's database. The access management application may also create and store a related audit record.

In the third example, a user's access to an application is revoked. In this case, a user (e.g., a user, human resources or possibly an administrator) may request revocation of application A access. The access management application may send an approval request, if applicable. The administrator may approve the request (e.g., or order the revocation in the first place). The access management application requests a map and/or connector(s) for application A to the application management database. The application management database returns the appropriate map and/or connector(s). Using the connectors, the access management application sends commands (e.g., to delete a user name) to the application A database and/or the user information database. For example, the application may be deleted from a user's current access list in the user information database. The access management application may also create and store an audit record of the operation(s) performed. The process for revocation of application access may be particularly useful when an employee is terminated from a company or no longer needs access to a particular application.

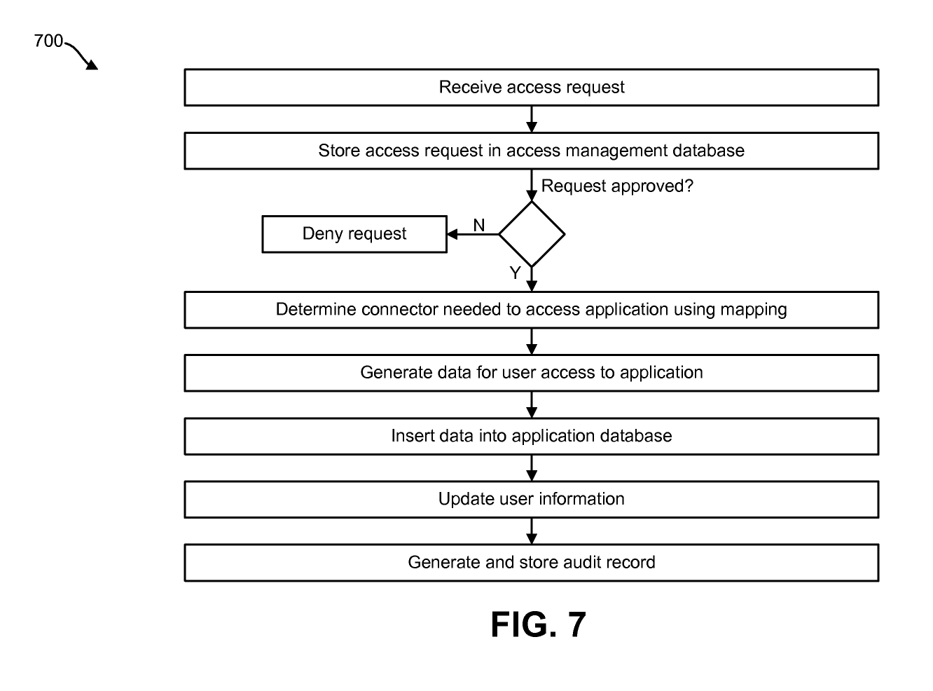

FIG. 7 is a flow diagram illustrating a more specific configuration of a method 700 for adding user access to an application. An access management application may receive an access request. The access management application may store the access request in an access management database. The access management application may then determine whether the request for access was approved. For example, the access management application may receive an approval or denial of the request from an administrator. If the administrator denies the request, the access management application may deny the request, possibly sending a notification to the user requesting access.

If the administrator approves the request, the access management application may determine which connector is needed to access the application to which access is desired or a database (e.g., the database(s) handling the application access information such as an application database and/or the user information database). The access management application may generate appropriate data to grant a user access to an application. For example, the access management application may generate a user name, password, role, permissions or other data as appropriate for the application at hand. The access management application may insert this data into one or more databases (e.g., application database(s) and/or the user information database). The access management application may update the user information (e.g., in the user information database) to reflect the access. For example, the access management application may add the application to the user's current access list. The access management application may also generate and store one or more audit records in the audit database reflecting the operations performed.

Thus, the systems and methods disclosed herein may provide a workflow for managing access requests as illustrated by FIGS. 5, 6 and 7. Using connectors, automated account (e.g., access) setup and management may be achieved by this workflow (with appropriate approvals, for example), which may be under a single audit framework. Furthermore, the systems and methods disclosed herein may provide a user with the ability to request access to one or more applications. The auditing functionality disclosed herein further provides a tracking mechanism for application access management (e.g., by tracking requests, approval/denial of access and users responsible for those actions, etc.).

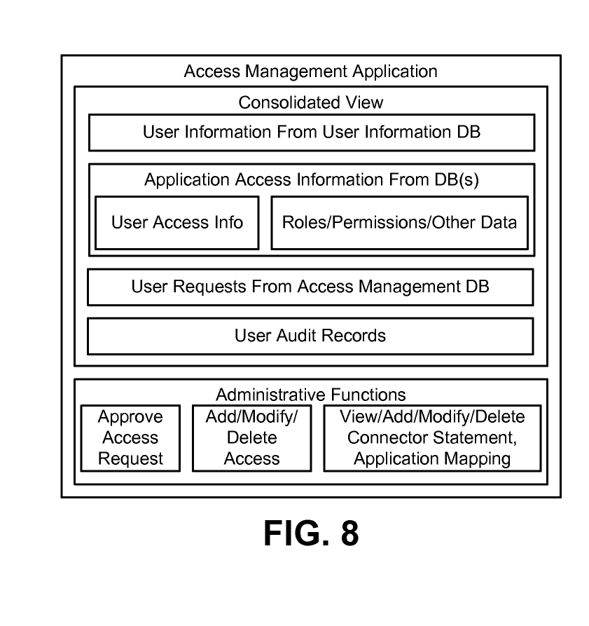

FIG. 8 is a block diagram illustrating one example of an access management application according to systems and methods for managing application access. The access management application may generate a consolidated view and/or administrative functions. For example, the access management application may display a consolidated view of one or more users' application access. In general, the consolidated view may provide a single view of at least one user's information and application access that may be retrieved by and/or from multiple disparate systems. The consolidated view may include user information from the user information database. For example, the access management application may retrieve information from the user information database using an appropriate connector. This information may include data such as a user's name, identification, employee number, etc.

The access management application may also display application access information from one or more databases. For example, the access management application may retrieve data from one or more applications, application databases and/or from the user information database using the appropriate connectors. For example, the consolidated view may display user access information from the user access list or the access information from the user information database. Furthermore, the access management application may display roles, permissions and/or other data from the user information database. Additionally or alternatively the consolidated view may display user access information from one or more application databases. The consolidated view may also display roles, permissions and/or other data from one or more application databases. This information may be retrieved from the one or more application databases using one or more appropriate connectors.

The consolidated view may display one or more user requests from the access management database. For example, one or more application access requests from a user may be recorded in the application management database. These application access requests may be retrieved and displayed in the consolidated view by the access management application. The access management application may also retrieve and display audit records pertaining to one or more users.

The access management application may also provide administrative functions. For example, the access management application may allow an administrator to approve or deny an application access request. The administrative functions may also include functions to add, modify and/or delete a user's access to one or more applications. Additionally, functions to view, add, modify or delete connectors or their statement may be provided. The administrative functions may also include functions to view, add, modify or delete application mappings (e.g., application to connector mappings and/or access data mappings).

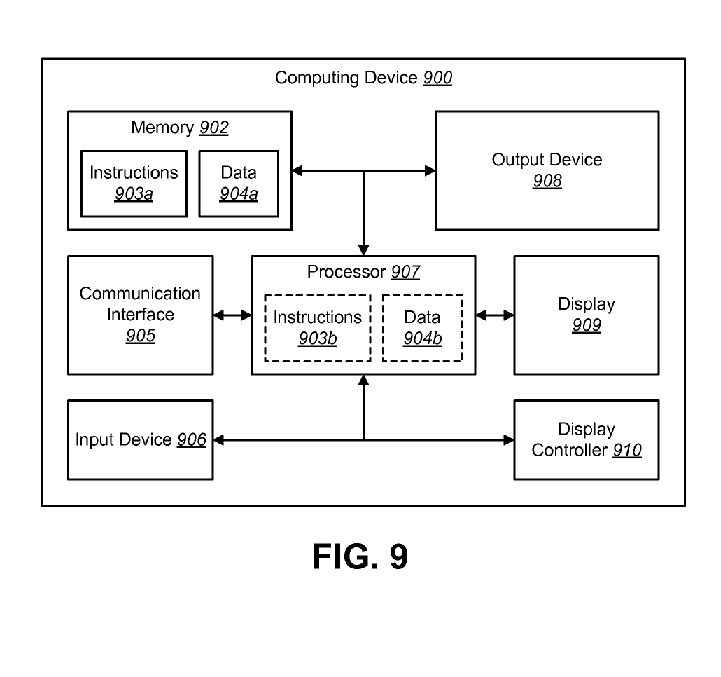

FIG. 9 illustrates various components that may be utilized in a computing device 900. The illustrated components may be located within the same physical structure or in separate housings or structures.

The computing device may include a processor and memory. The processor controls the operation of the computing device and may be, for example, a microprocessor, a microcontroller, a digital signal processor (DSP) or other device known in the art. The processor typically performs logical and arithmetic operations based on program instructions and data stored within the memory. Instructions and data may also be loaded onto the processor.

The computing device typically may include one or more communication interfaces for communicating with other electronic devices. The communication interfaces may be based on wired communication technology, wireless communication technology, or both. Examples of different types of communication interfaces include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device typically may include one or more input devices and one or more output devices. Examples of different kinds of input devices include a keyboard, mouse, microphone, remote control device, button, joystick, trackball, touchpad, lightpen, etc. Examples of different kinds of output devices include a speaker, printer, etc. One specific type of output device which may be typically included in a computer system is a display device. Display devices used with configurations disclosed herein may utilize any suitable image projection technology, such as a cathode ray tube (CRT), liquid crystal display (LCD), light-emitting diode (LED), gas plasma, electroluminescence, or the like. A display controller may also be provided, for converting data stored in the memory into text, graphics, and/or moving images (as appropriate) shown on the display device.

Of course, FIG. 9 illustrates only one possible configuration of a computing device 900. Various other architectures and components may be utilized.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “computer-readable medium” refers to any available medium that can be accessed by a computer or processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A computing device that is configured for managing application access, comprising:
a processor;
memory in electronic communication with the processor;
instructions stored in the memory, the instructions being executable to:
determine, using a mapping, one or more connectors needed to execute one or more commands;
execute the one or more commands using the one or more connectors;
update user information to reflect any changes; and
generate and store one or more audit records.

2. The computing device of claim 1, wherein executing the one or more commands provides a consolidated view of application access information for one or more users.

3. The computing device of claim 2, wherein the application access information is retrieved from multiple different sources.

4. The computing device of claim 3, wherein the multiple different sources comprise a user information database and one or more application databases.

5. The computing device of claim 1, wherein the one or more commands are selected from a group consisting of:
one or more commands to retrieve application access for one or more users;
one or more commands to add application access for one or more users;
one or more commands to remove application access for one or more users; and
one or more commands to modify access for one or more users.

6. The computing device of claim 1, wherein the one or more commands are selected from a group consisting of:
one or more commands to retrieve one or more user permissions;
one or more commands to add one or more user permissions;
one or more commands to remove one or more user permissions; and
one or more commands to modify one or more user permissions.

7. The computing device of claim 1, wherein the one or more commands are selected from a group consisting of:
one or more commands to retrieve one or more user roles;
one or more commands to add one or more user roles;
one or more commands to remove one or more user roles; and
one or more commands to modify one or more user roles.

8. The computing device of claim 1, wherein the one or more commands comprise a command to retrieve application access information, user information and one or more audit records for one or more users.

9. The computing device of claim 8, wherein the application access information is stored in one or more application databases or a user information database, the user information is stored in the user information database and the one or more audit records are stored in an audit database.

10. The computing device of claim 9, wherein the one or more application databases, the user information database and the audit database are located on one computing device.

11. The computing device of claim 9, wherein the one or more application databases, the user information database and the audit database are located on separate computing devices.

12. The computing device of claim 1, wherein the command originates from one of a group consisting of a local computing device and a remote computing device.

13. The computing device of claim 1, wherein the one or more connectors are stored in an access management database.

14. The computing device of claim 1, wherein the instructions are further executable to receive and store an application access request from one or more users.

15. The computing device of claim 14, wherein the instructions provide an automated workflow for managing user access requests.

16. The computing device of claim 1, wherein the instructions are further executable to receive approval of one or more user access requests.

17. The computing device of claim 1, wherein executing the one or more commands provides access to multiple applications.

18. The computing device of claim 17, wherein the user information is a single set of information used to access the multiple applications.

19. The computing device of claim 3, wherein the multiple different sources are searchable.
